(19) United States
(12) Patent Application Publication
(10) Pub. No.: US 2026/0003827 A1
(43) Pub. Date: Jan. 1, 2026

(54) PROCESSING APPARATUS, IMAGE FORMING APPARATUS, AND PROCESSING METHOD OF PROCESSING APPARATUS

(71) Applicant: SHARP KABUSHIKI KAISHA, Sakai City (JP)

(72) Inventor: HARUNOBU MORI, Sakai City (JP)

(21) Appl. No.: 19/243,805

(22) Filed: Jun. 20, 2025

(30) Foreign Application Priority Data
Jun. 27, 2024 (JP) 2024-104246

(51) Int. Cl. G06F 16/16; G06F 16/23

(52) U.S. Cl. CPC G06F 16/162; G06F 16/2379

(57) ABSTRACT

A processing apparatus of the disclosure includes an acquirer that acquires data including information of a date and time at which the data has been generated as a date and time attribute, a storage that stores the acquired data, and at least one controller The at least one controller updates the date and time attribute of the data acquired by the acquirer with a date and time acquired by the acquirer, and deletes data being present after a lapse of a predetermined period from a date and time of the date and time attribute among pieces of the data in the storage.

### CROSS-REFERENCE TO RELATED APPLICATION

The present application claims priority from Japanese Application JP2024-104246, the content of which is hereby incorporated by reference into this application.

### BACKGROUND OF THE INVENTION

### 1. Field of the Invention

The disclosure relates to a processing apparatus, an image forming apparatus, and a processing method of a processing apparatus.

### 2. Description of the Related Art

For example, as related art, there is known a technique of judging whether the storage time limit of a digital image has expired, based on a date, and automatically deleting the digital image when the storage time limit has expired.

### SUMMARY OF THE INVENTION

An object of the disclosure is to provide a processing apparatus, an image forming apparatus, and a processing method of a processing apparatus, which are capable of deleting saved data at an appropriate timing, for example.

The processing apparatus of the disclosure includes an acquirer that acquires data including information of a date and time at which the data has been generated as a date and time attribute, a storage that stores the acquired data, and at least one controller, in which the at least one controller updates the date and time attribute of the data acquired by the acquirer with a date and time acquired by the acquirer, and deletes data being present after a lapse of a predetermined period from a date and time of the date and time attribute among pieces of the data in the storage.

The image forming apparatus of the disclosure includes an acquirer that acquires content data including a date and time at which the data has been generated as attribute information, a storage that stores the acquired content data, an image former that forms an image based on the content data, and at least one controller, in which the at least one controller updates a date and time attribute of the data acquired by the acquirer with a date and time acquired by the acquirer, and deletes the content data being present after a lapse of a predetermined period from a date and time of the date and time attribute among pieces of the content data in the storage.

The processing method of the processing apparatus of the disclosure includes an acquiring step of acquiring data including information of a date and time at which the data has been generated as a date and time attribute, a storing step of storing the acquired data in a storage, an updating step of updating the date and time attribute of the data acquired by the acquiring step with a date and time acquired by the acquiring step, and a deleting step of deleting data being present after a lapse of a predetermined period from a date and time of the date and time attribute among pieces of the data in the storage.

According to the disclosure, it is possible to provide a processing apparatus, an image forming apparatus, and a processing method of the processing apparatus, which are capable of deleting saved data at an appropriate timing, for example.

### BRIEF DESCRIPTION OF THE DRAWINGS

FIG. 1 is a diagram for describing an overview of a system according to a first embodiment.

FIG. 2 is a diagram for describing a hardware configuration of an image forming apparatus according to the first embodiment.

FIG. 3 is a diagram for describing a software configuration according to the first embodiment.

FIG. 4 is a diagram for describing an example of a system setting according to the first embodiment.

FIG. 5 is a diagram for describing attributes of content data according to the first embodiment.

FIG. 6 is a flowchart for describing operations of a first process according to the first embodiment.

FIG. 7 is a diagram for describing an example of a system setting screen according to the first embodiment.

FIG. 8 is a diagram for describing an example of a system setting screen according to the first embodiment.

FIG. 9 is a diagram for describing attributes of content data according to a second embodiment.

FIG. 10 is a flowchart for describing operations of a second process according to the second embodiment.

FIG. 11 is a diagram for describing attributes of content data according to a third embodiment.

FIG. 12 is a flowchart for describing operations of a third process according to the third embodiment.

FIG. 13 is a flowchart for describing operations of a fourth process according to a fourth embodiment.

FIG. 14 is a flowchart for describing operations of a fifth process according to a fifth embodiment.

### DETAILED DESCRIPTION OF THE INVENTION

Embodiments of the disclosure will be described below with reference to the drawings. Note that the embodiments described below are embodiments that provide the disclosure, and the content of the disclosure is not to be interpreted as being limited based on the description below.

For example, there is known a processing apparatus configured to automatically delete data imported from the outside when a predetermined time has elapsed since then. For example, in an image forming apparatus, in order to ensure security for image data imported from the outside, imported job data, and the like, there is known a technique in which data that is present after a lapse of fixed hours is deleted.

However, depending on a setting of the deletion timing, there arises a problem that the data is deleted earlier than expected by the user. For example, when data to which a data generation date and time is attached as a date and time attribute is directly imported as is to another device, the data may be automatically deleted immediately after the import. Thus, when a user attempts to use the data, there is a problem that the imported data does not exist. In order for the processing apparatus to be able to judge a timing at which the data imported from the outside is to be deleted, it is needed to add an attribute such as a save time limit to the data, for example, but this scheme cannot be generally used.

In particular, in a device in which a setting to delete data after a lapse of several hours can be made, it is assumed that a noticeable problem that necessary data is deleted immediately after being imported to the device arises.

In order to solve such problems, in the following embodiments, a processing apparatus and the like in which data is deleted at an appropriate timing will be described.

### 1. First Embodiment

### 1.1 Entirety of System

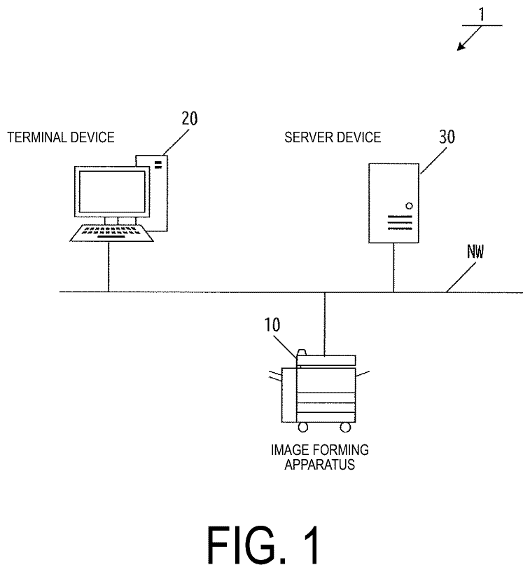

FIG. 1 is a diagram for describing an overview of a system 1. FIG. 1 is a diagram for describing an overview of the system 1 including an image forming apparatus 10 as a processing apparatus.

The system 1 may include, in addition to the image forming apparatus 10, a terminal device 20 and a server device 30 capable of communicating with the image forming apparatus 10 via a network NW.

The image forming apparatus 10 is a device referred to as, for example, a multifunction printer or a Multifunction Peripheral/Printer/Product (MFP). For example, when executing a job (print job), the image forming apparatus 10 can form an image on paper which is a recording medium. The image forming apparatus 10 can execute a job for multiple processing operations such as copy processing, FAX processing, scan processing, and print processing, as a job to be executed.

The terminal device 20 is a device used by a user or an administrator. For example, the user transmits a print job from the terminal device 20 to the image forming apparatus 10. By executing the received print job, the image forming apparatus 10 performs printing on a recording sheet based on print data, for example. By accessing the image forming apparatus 10 from the terminal device 20, the administrator can, for example, perform setting of the image forming apparatus 10.

The server device 30 may manage, for example, user information. The server device 30 may collectively manage the user information by using, for example, a Lightweight Directory Access Protocol (LDAP) service.

The terminal device 20 and the server device 30 are provided as necessary in the system 1. For example, one terminal device 20 or multiple terminal devices 20 may be connected. The server device 30 may use, for example, an external service (e.g., a service provided on a cloud).

The network NW connecting the image forming apparatus 10, the terminal device 20, and the server device 30 may be any of communication lines or communication systems, and may use a wireless or wired Local Area Network (LAN), the Internet, a public network, or a communication system such as mobile communication (e.g., mobile communication such as 4G/5G/6G) or a next-generation telephone network.

### 1.2 Hardware Configuration

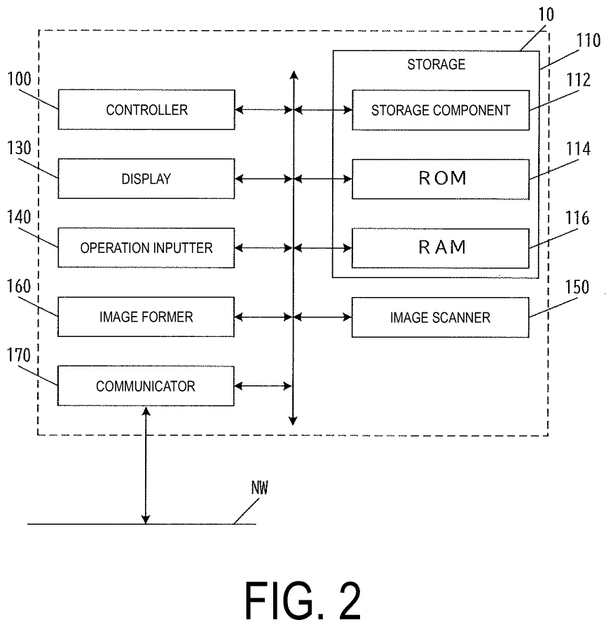

A hardware configuration of the image forming apparatus 10 in the present embodiment will be described with reference to FIG. 2. FIG. 2 is a diagram for describing an example of the image forming apparatus 10.

As illustrated in FIG. 2, the image forming apparatus 10 includes at least one controller 100 as a control device, at least one storage 110 (including a storage component 112, a Read Only Memory (ROM) 114, and a Random Access Memory (RAM) 116) as a storage device, at least one display 130 as a display device, at least one operation inputter 140 as an operation device, at least one image scanner 150 as a reading device, at least one image former 160 as a printing device, and at least one communicator 170 as a communication device.

The controller 100 controls an entirety of the image forming apparatus 10. The controller 100 enables various functions by loading and executing various programs stored in the storage 110 (for example, the storage component 112 or the ROM 114). The controller 100 may be implemented by one or multiple control devices/arithmetic devices (such as a Central Processing Unit (CPU), a System on a Chip (SoC)). The controller 100 may include one or multiple control circuits.

The storage 110 stores programs, data, and the like. The storage 110 may be configured by, for example, the storage component 112, the ROM 114, the RAM 116, and the like. In addition, the storage 110 may include, for example, a cache memory or the like included in another functional unit (e.g., the controller 100, the communicator 170, or the like).

The storage component 112 is a non-volatile storage device capable of storing programs and data. For example, the storage component 112 may be configured of a storage device such as a Hard Disk Drive (HDD) or a Solid State Drive (SSD). The storage component 112 may be configured as a USB memory that can be connected to an external device. The storage component 112 may be, for example, a storage area on a cloud.

The ROM 114 is a non-volatile memory capable of holding programs and data even in a case that the power is turned off.

The RAM 116 is a main memory mainly used when the controller 100 executes processing. The RAM 116 is a rewritable memory that temporarily holds a program loaded from the storage component 112, the ROM 114 or the like, and data including execution results.

The display 130 is a display device that can display various types of information and execution screens. The display 130 may include, for example, a display device such as a Liquid Crystal Display (LCD), an Organic Electro Luminescence (EL) display, or an electrophoresis display. The display 130 includes an interface to which the display device can be connected. For example, the display 130 may include an external display device connected via a High-Definition Multimedia Interface (HDMI) (trade name), a Digital Visual Interface (DVI), or a Display Port.

The operation inputter 140 is an operation device that can receive operations from a user. For example, the operation inputter 140 may be an operation device such as a touch panel integrated with the display 130 or an operation button. The operation inputter 140 may be an operation device such as a keyboard or a mouse. The operation inputter 140 may also include an interface (for example, a Universal Serial Bus (USB)) to which an operation device can be connected. For example, a different operation device (an operation device including a touch panel) may be connected to the image forming apparatus 10.

The image scanner 150 scans a document (image) and outputs the document as image data. The image scanner 150 is, for example, a scanner, and may be a reading device using a Charge Coupled Device (CCD) or a Contact Image Sensor (CIS). Note that the image scanner 150 may read out image data from a recording medium such as a USB memory or an SD card (trade name). The image scanner 150 may read out image data from a terminal device such as a smartphone connected to the image forming apparatus 10 via the communicator 170.

The image former 160 forms an image on, for example, a recording sheet. The image former 160 includes, for example, an image carrier, and forms an image by forming a toner image on the image carrier and transferring the image on the image carrier onto the recording sheet. The image former 160 may be configured as an image forming apparatus such as a printer. The image former 160 may electronically form an image as an image file.

The communicator 170 is a communication interface that communicates with other devices. The communicator 170 may be, for example, a network interface capable of providing wired connection such as Ethernet (trade name) or wireless connection such as IEEE802.11a/b/g/n. Further, the communicator 170 may provide a function of serving as a base station of other devices, as wireless communication.

In the present embodiment, the communicator 170 can communicate with other devices via the network NW. In addition, the communicator 170 may be equipped with a communication scheme for connecting to a terminal device such as a smartphone. For example, the communicator 170 may communicate with the terminal device by a communication scheme of short-range wireless communication such as Bluetooth (trade name) or Near Field Communication (NFC).

The terminal device 20 and the server device 30 may be general-purpose information processing apparatuses. For example, one or more of the functions of the controller, the storage (storage component, ROM, RAM), the display, the operation inputter, the communicator, and the like are provided. Since the configurations of the terminal device 20 and the server device 30 are obvious, detailed description thereof is omitted.

### 1.3 Software Configuration

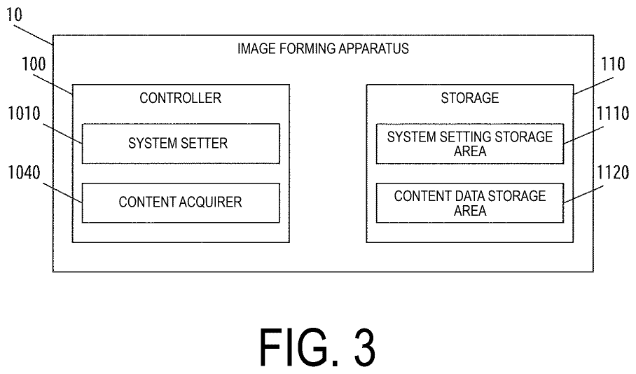

A configuration of main software in the image forming apparatus 10 of the system 1 will be described with reference to FIG. 3. Note that, in the software configuration illustrated in FIG. 3, configurations necessary for the present embodiment are mainly described, and other configurations are omitted. For example, the image forming apparatus 10 may further include a configuration such as an image processor or a power controller that provides a function necessary for the image forming apparatus 10.

The controller 100 of the image forming apparatus 10 functions as each of the configurations described below by performing a program (application) stored in the storage 110.

A system setter 1010 performs setting related to a system for operating the image forming apparatus 10 (hereinafter, referred to as “system setting”). The system setting set by the system setter 1010 is stored in a system setting storage area 1110 of the storage 110.

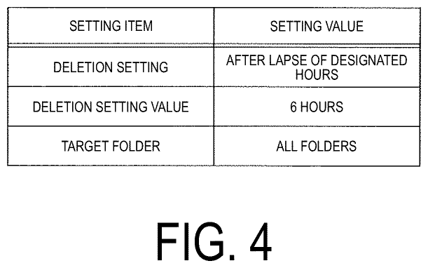

The system setting storage area 1110 stores various settings necessary for operations of the image forming apparatus 10 as the system setting, but only items necessary in the present embodiment will be described with reference to FIG. 4.

The system setting storage area 1110 stores setting items and setting values in association with each other. As the setting items, a type of deletion setting (for example, “after lapse of designated hours”), a deletion setting value (for example, “6 hours”) corresponding to the deletion setting, and target folders to be deleted (for example, “all folders”) are stored.

As described above, the content of the system setting illustrated in FIG. 4 is an example. As the system setting, other setting items may be stored, or unnecessary setting items in FIG. 4 need not be stored.

A content acquirer 1040 acquires content data. The content data includes image data, document data, and job data. Then, the content acquirer 1040 stores the acquired content data in a content data storage area 1120.

The content acquirer 1040 acquires the content data as follows.

(1) Acquire from Image

For example, the content acquirer 1040 may acquire image data from the image scanner 150. Image data is generated when the image scanner 150 scans a document, and the content acquirer 1040 acquires the generated image data as content data. The data generated by the image scanner 150 is not necessarily needed to be image data, and may be document data in the Portable Document Format (PDF), for example.

(2) Acquire from File

The content acquirer 1040 may acquire an image file, a document file, or the like as content data, from the image scanner 150 or the communicator 170. For example, the content acquirer 1040 may acquire content data from the terminal device 20 or may acquire content data from the server device 30, via the communicator 170. The content acquirer 1040 may read out a file recorded in a recording medium via the image scanner 150 and acquire the file as content data.

The attributes of the content data may be stored in the content data storage area 1120. The attributes of the content data may be stored as attributes in the content data itself (for example, a file corresponding to the content); alternatively, a table for managing the content data may be used.

The content data may be directly stored in the content data storage area 1120, or may be stored in another area or another device. In the content data storage area 1120, information (link information, shortcut information) on a location where the content data is specifically stored may be stored.

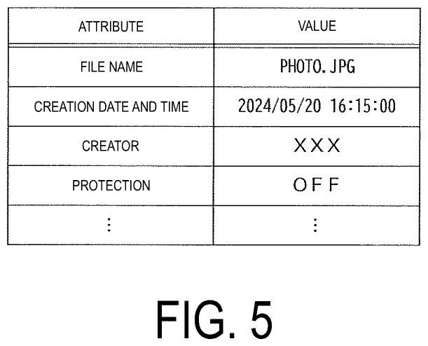

FIG. 5 is a diagram for describing an example of attributes of content data. For example, a file name (e.g., “PHOTO.JPG”), a date and time when the content data has been created (e.g., “2024 May 20 16:15:00”), a creator of the content data (e.g., “XXX”), and a protection attribute of the content data (e.g., “OFF”) are stored as attributes for a certain content, and one or more pieces of the above information may be stored. An attribute may be added later to the attributes of the content data stored in the content data storage area 1120 by the controller 100 as needed.

### 1.4 Processing Flow

Now, a processing flow according to the present embodiment will be described with reference to the figures. Note that the processing below will be described with a focus on clarifying the features of the disclosure.

### 1.4.1 First Process

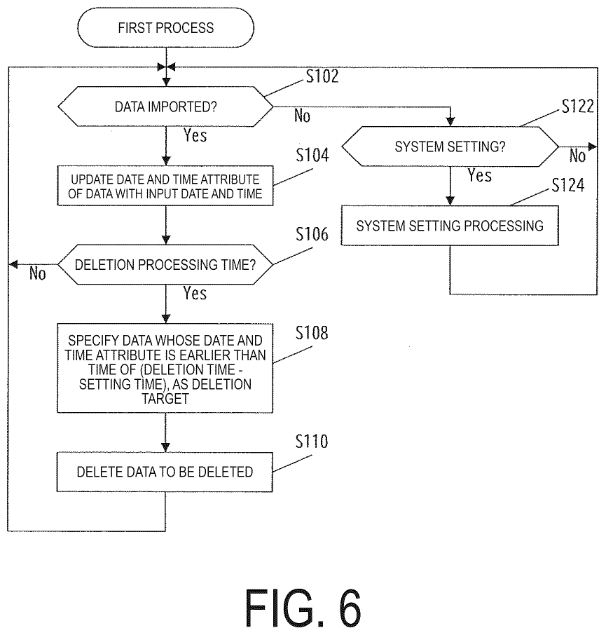

FIG. 6 is a diagram for describing a process (first process) according to the present embodiment. The controller 100 judges whether content data is imported (S102). Here, the controller 100 importing content data may refer to, for example, the content acquirer 1040 reading out an image from the image scanner 150. Further, the controller 100 importing content data may refer to, for example, the content acquirer 1040 acquiring data from another device via the communicator 170. Furthermore, importing content data may refer to the controller 100 reading content data stored in a USB memory, for example.

Here, the data imported by the controller 100 is content data, but may be image data, document data, or job data, for example.

When content data is imported (S102; Yes), the controller 100 updates the date and time attribute of the content data with an input date and time (S104). Here, as the date and time attribute of the content data, in the first embodiment, for example, the date and time when the content data has been generated is stored. That is, the content data includes, as an attribute, the date and time when the content data has been generated at an import destination (acquisition destination) or when the content data has been saved at the import destination. That is, the attribute of the date and time included in the attributes of the content data is given in a device of the import destination or in a device in which the content data has been generated and saved. Further, the attribute of the date and time of the content data may be stored as an attribute of the data or may be stored as a time stamp of a file.

Then, the controller 100 updates the date and time attribute of the content data with the date and time at a time point when the content data has been imported (the date and time at an importing time point). With this, the date and time attribute of the content data imported into the image forming apparatus 10 comes to be the date and time at a time point when the content data has been imported into the image forming apparatus 10.

The controller 100 judges whether the time has come to a set deletion processing time (which may be simply referred to as a deletion time) (S106). For example, the controller 100 may judge that every hour on the hour is a deletion time, or may judge that the deletion time is reached at predetermined time intervals such as 3:00, 6:00, 9:00, and the like.

The controller 100 specifies content data to be deleted from the content data stored in the storage 110. In the first embodiment, the controller 100 specifies the content data whose date and time attribute is earlier than a date and time obtained by subtracting a setting time from the deletion time (the deletion time judged in S106, the current time at the time point of deletion, or the like), as content data to be deleted (S108).

In this case, the setting time may be set by a user. For example, when the user does not want to delete content data for six hours, the setting time is set to six hours. The setting time may be set by an administrator or may be set in advance by the system.

At this time, the controller 100 specifies a file to be deleted from among all the files of the content data stored in the storage 110 in principle.

Then, the controller 100 deletes the content data specified as a deletion target (S110).

The deletion time and the setting time can be set by the system setting. For example, when the user selects the system setting without content data being imported (S102; No→S122; Yes), the controller 100 executes system setting processing (S124).

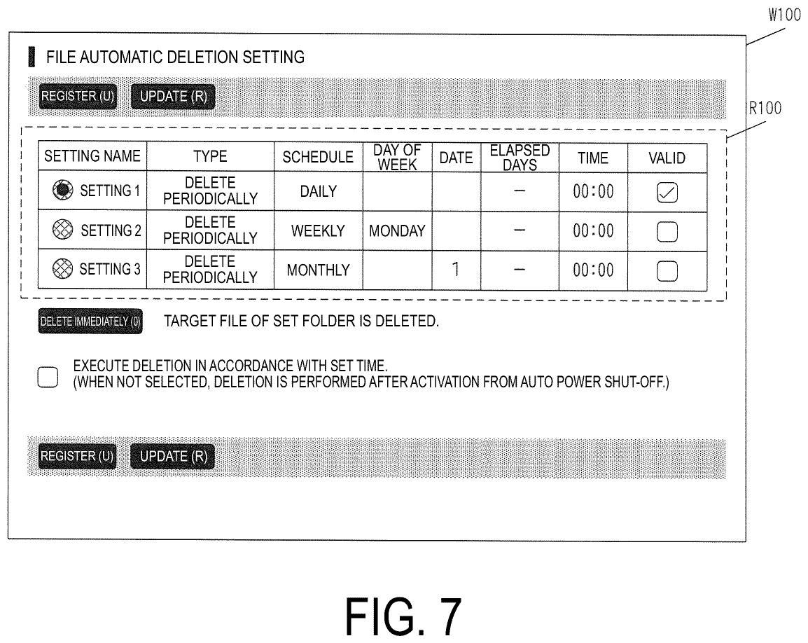

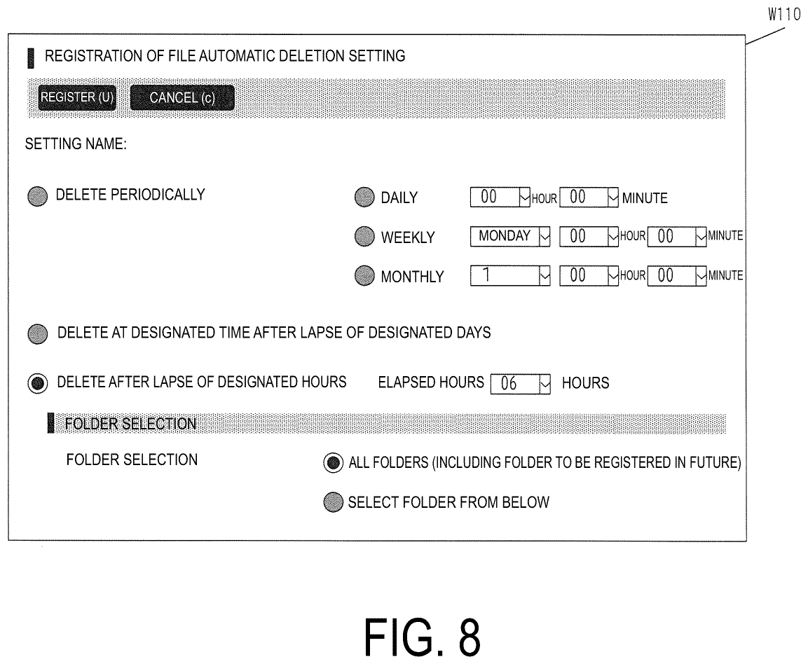

For example, FIG. 7 illustrates an example of a display screen W100 displayed on the display 130 when file automatic deletion is set in the system setting processing. FIG. 8 is an example of a display screen W110 displayed on the display 130 when the file automatic deletion is registered.

In the display screen of FIG. 7, a setting for deleting a file is displayed in an area R100. For example, when the user selects any one of setting 1 to setting 3, the screen display is switched to that of FIG. 8, and a schedule for file deletion can be set.

In the area R100 of FIG. 7, a list of schedules for file deletion is displayed. By the list being displayed in the areas R100, the user can check at which timing the file is deleted in each of settings 1 to 3. Here, the controller 100 executes the schedule with a column of “valid” check-marked.

In FIG. 7, a “delete immediately” button may be displayed. When the user selects the “delete immediately” button, the controller 100 executes file deletion processing regardless of the schedule. When the “delete immediately” button is selected, the controller 100 may execute only the schedule with the column of “valid” check-marked.

For example, FIG. 8 illustrates an example of the display screen W110 displayed on the display 130 in the system setting processing. The display screen W110 of FIG. 8 may be displayed when any one of settings 1 to 3 is selected in the display screen W100 of FIG. 7. The display screen W110 of FIG. 8 may be displayed without the display screen W100 of FIG. 7 being displayed. For example, in a case where only one schedule setting is stored, the image forming apparatus 10 is only required to display the display screen W110 of FIG. 8.

Here, in FIG. 8, the controller 100 causes at least any one of three timings to be selected as a timing for file deletion. For example, as the timing for file deletion, the user can select and set any of “delete periodically”, “delete at designated time after lapse of designated days”, and “delete after lapse of designated hours”. One of these rules (deletion rules) may be selectable with, for example, a radio button.

Here, when the user selects “delete periodically” and selects “daily”, the user can further set a time for deletion. When the user selects “delete periodically” and selects “weekly”, the user can set a day of the week and a time for deletion. When the user selects “delete periodically” and selects “monthly”, the user can set a date and a time for deletion.

When the user selects “delete at designated time after lapse of designated days”, elapsed days and a deletion time can be set. When the user selects “delete after lapse of designated hours”, elapsed hours after the file is saved can be set.

Further, the user can select a folder to which the deletion rule is applied. The user can select any of “all folders (including folder to be registered in future)” and “select folder from below”. In the case where the user selects “select folder from below”, the user can designate a folder to which the deletion rule is applied. As for a file assigned with a password or the like such as a protection file or a confidential file, the user can select and set whether the file is to be deleted or not.

To be specific, in the display screen W110 illustrated in FIG. 8, as the setting items described in FIG. 4, the deletion settings are displayed in such a manner as to be selected by radio buttons. For example, when “delete after lapse of designated hours” is selected, the setting value of the setting item “deletion setting” of the system setting in the system setting storage area 1110 in FIG. 4 is updated to “after lapse of designated hours”.

At this time, the elapsed hour “6 hours” is selected as a parameter by the user with the pull-down menu. The controller 100 sets the setting value “6 hours” of the set elapsed hour to the setting value of the setting item “deletion setting value” of the system setting. Hours selectable with the pull-down menu can be, for example, any of one hour, two hours, three hours, six hours, eight hours, and twelve hours, but are not limited thereto, and any optional hours may be set.

### 1.5 Operation Examples

The following description is given based on specific operation examples. For example, a case will be described as an example in which every hour on the hour is set as a deletion time and the deletion setting value is set as “6 hours” in the image forming apparatus 10.

For example, a case will be described in which the controller 100 imports image data “TEST.JPG” created at “2023 Oct. 10 12:00:00” into the storage 110 at “2024 May 20 12:30:00”.

The controller 100 updates the date and time attribute of the image data “TEST.JPG” to “2024 May 20 12:30:00” which is a date and time at which the image data is imported.

Next, the controller 100 determines 13:00 as a deletion time. However, the image data of “TEST.JPG” is not a deletion target and is stored as it is, because only one hour has passed when the date and time attribute is compared with 13:00.

When a plurality of deletion times have passed and 19:00 becomes a deletion time, more than six hours have passed since the date and time attribute “2024 May 20 12:30:00”. Thus, the controller 100 determines the image data as a deletion target at a 19:00 time point, and deletes the image data from the storage 110.

### 1.6 Effect

As described above, according to the present embodiment, when data is imported (at the time of import), the attribute value of the creation date and time among the attribute values of the data is updated with the date and time at which the data is imported. As a result, the data is not automatically deleted until hours equal to or more than the elapsed hours set after the data import pass.

### 2. Second Embodiment

In the first embodiment, the controller 100 updates the date and time among the attributes of the content data with the date and time at which the creation date and time is imported. The second embodiment is an embodiment having an attribute including a creation date and time and an imported date and time.

The second embodiment has the same hardware and software configurations as the first embodiment. In the present embodiment, points different from the first embodiment will be mainly described.

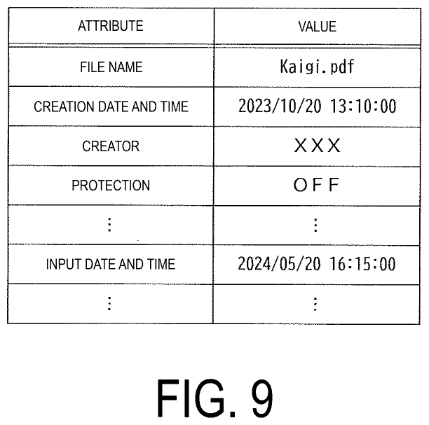

FIG. 9 is a diagram for describing attributes of content data according to the present embodiment. For example, compared to the attributes of the data in the first embodiment discussed with reference to FIG. 5, an input date and time (e.g., “2024 May 20 16:15:00”) is added.

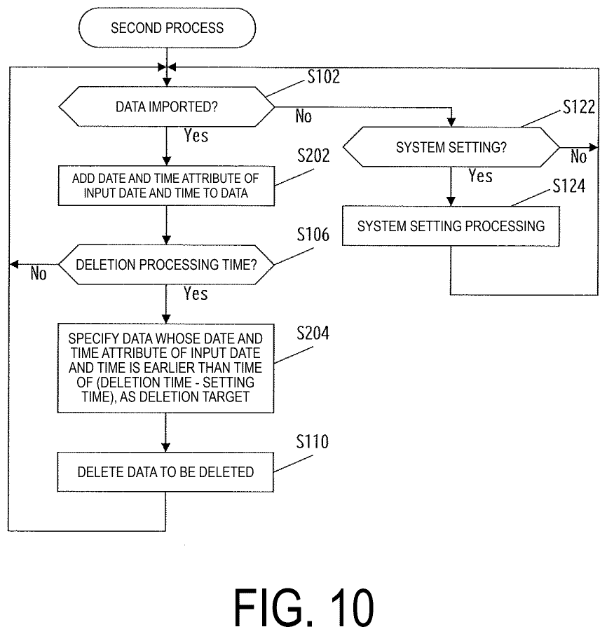

In the second embodiment, the controller 100 executes a second process in FIG. 10 in place of the first process. Hereinafter, the same processing as that in the first embodiment is denoted by the same reference sign, and description thereof is omitted.

When content data is imported (S102; Yes), the controller 100 adds a date and time attribute of the input date and time of the content data (S202). That is, in the present embodiment, the date and time at which the content data has been imported is stored as the date and time attribute of the content data while the date and time at which the content data has been created being stored. For example, when the image scanner 150 generates image data by scanning a document, a date and time when the image data is generated is recorded as the creation date and time and the input date and time of the content data, and when the content data is acquired from another device via the communicator 170, the input date and time is updated with a date and time when the content data is imported.

Therefore, when the time comes to a deletion processing time (S106; Yes), the controller 100 judges whether the setting time has elapsed based on the date and time attribute of the input date and time (S204). That is, in the present embodiment, the controller 100 specifies the content data whose date and time attribute is a date and time, at which the content data has been imported, and which is earlier than a date and time obtained by subtracting the setting time from the deletion time (the deletion time judged in S106, the current time at the time point of deletion, or the like), as content data to be deleted.

As described above, according to the present embodiment, it is possible to judge whether the content data is allowed to be automatically deleted, based on the date and time at which the content data has been imported and which has been added as the date and time attribute while the creation date and time of the content data being stored.

By doing so, the content data is not automatically deleted during a period from when the content data is imported to when a save period elapses. As the storage destination of the imported date and time, an area or an attribute in which the creation date and time or the save date and time of the content data is recorded may be used. At the time of import (the time of importing), the creation date and time, the save date and time, and the like of the content data may be overwritten with the imported date and time.

### 3. Third Embodiment

In the first embodiment and the second embodiment, based on a date and time when a file has been imported, the controller 100 determines the file being present after a lapse of setting times from the date and time when the file has been imported as a target of automatic deletion. The third embodiment is an embodiment in which flag information is used, instead of the date and time when the file has been imported, to cause content data to be not automatically deleted.

The third embodiment has the same hardware and software configurations as the first embodiment (or the second embodiment). In the present embodiment, points different from the first embodiment will be mainly described.

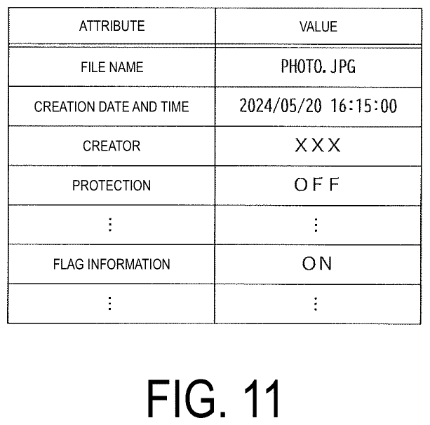

FIG. 11 is a diagram for describing attributes of content data according to the present embodiment. For example, compared to the attributes of the data in the first embodiment discussed with reference to FIG. 5, flag information (e.g., “ON”) is added.

In this case, the flag information is information indicating that the content data is not a deletion target. For example, when the flag information is “ON”, the content data is not a deletion target. On the other hand, when the flag information is “OFF”, it indicates that the content data is a deletion target.

In FIG. 11, the value “ON” or “OFF” of the flag information indicates whether the content data is a deletion target, and the controller 100 is allowed not to determine the content data to which the flag information is added (the flag information is included in the attributes) as a deletion target.

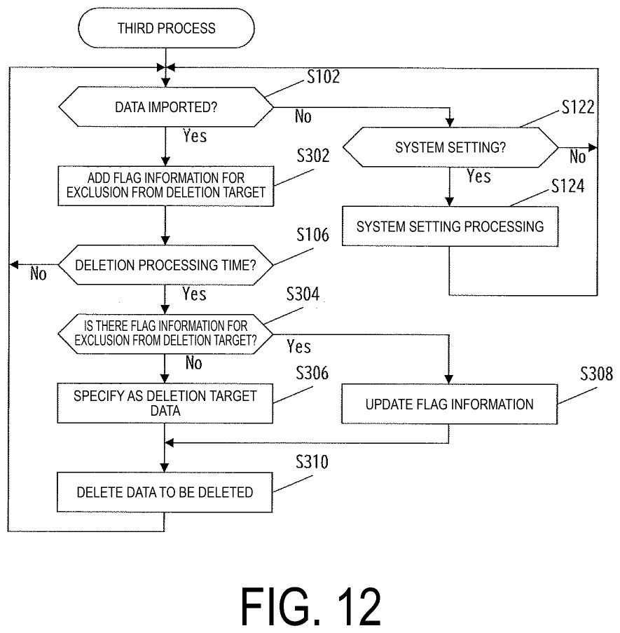

In the third embodiment, the controller 100 executes a third process in FIG. 12 in place of the first process. Hereinafter, the same processing as that in the first embodiment is denoted by the same reference sign, and description thereof is omitted.

When the content data is imported (S102; Yes), the controller 100 adds flag information for exclusion from a deletion target in the content data (S302). When the content data is imported by S102, the controller 100 first adds flag information to the content data.

Then, when the time has come to a deletion processing time (S106; Yes), it is judged whether there is flag information for exclusion from a deletion target with respect to each piece of the content data (S304). When there is no flag information for exclusion from a deletion target in the content data (for example, the flag information is not included in the attributes of the content data, the flag information is “OFF”, or the like) (S304; No), the content data is specified as content data to be deleted (S306).

On the other hand, when there is flag information for exclusion from a deletion target (S304; Yes) in the content data stored, the controller 100 updates the flag information (S308).

The following processing can be considered as a case where the controller 100 updates the flag information, for example.
(1) Remove Flag Information
(2) Change the value of the flag information from “ON” to “OFF”
(3) Decrement a setting value of the flag information. For example, in a case where “3” is stored as the setting value of the flag information, the controller 100 subtracts one from the setting value of the flag information to obtain “2” in S308 when executed for the first time. Then, when the setting value of the flag information becomes “0”, the controller 100 judges that the flag information of the content data is absent (removed).

As an operation example, a case where a deletion processing time at which content data is automatically deleted is reached every six hours is considered. Then, because the flag information is “ON” at the first deletion processing time after the content data has been imported, the controller 100 does not determine the content data as a deletion target. Then, the controller 100 updates the flag information to “OFF”.

Subsequently, when six hours have elapsed again, the controller 100 checks the deletion of the content data again. At this time, since the flag information has been removed from the content data previously judged not to be deleted, the controller 100 specifies the content data as a deletion target and then the specified content data is deleted.

As described above, according to the present embodiment, it is possible to appropriately manage the timing of deleting content data without storing the date and time at which the content data is imported.

With the above configuration, the content data is not automatically deleted until automatic deletion judgment is made twice or more after the content data has been imported. That is, when the content data is imported, the controller 100 sets a flag (import flag) indicating whether the content data has just been imported. After the automatic deletion judgment is made for the content data, the import flag of the content data may be reset. Thus, when the import flag is set, the controller 100 judges that the content data has just been imported. For example, the controller 100 executes the deletion judgment for automatically deleting the content data at a fixed time (e.g., every hour on the hour) or at a date and time designated by the user.

### 4. Fourth Embodiment

In the embodiments described above, it is judged whether the content data stored in the storage 110 is content data to be deleted. In a fourth embodiment, in a case where content data is stored in folder units, it is judged whether each folder is an automatic deletion target.

In the system setting, a folder to be deleted can be selected. For example, in the display screen W100 of FIG. 8, a folder can be selected. In the selection of a folder, for example, it is possible to select whether the content data stored in all folders is targeted or the content data stored in a specified folder is targeted.

For example, in the system setting illustrated in FIG. 4, the controller 100 may store information related to the folder to be deleted in the target folder.

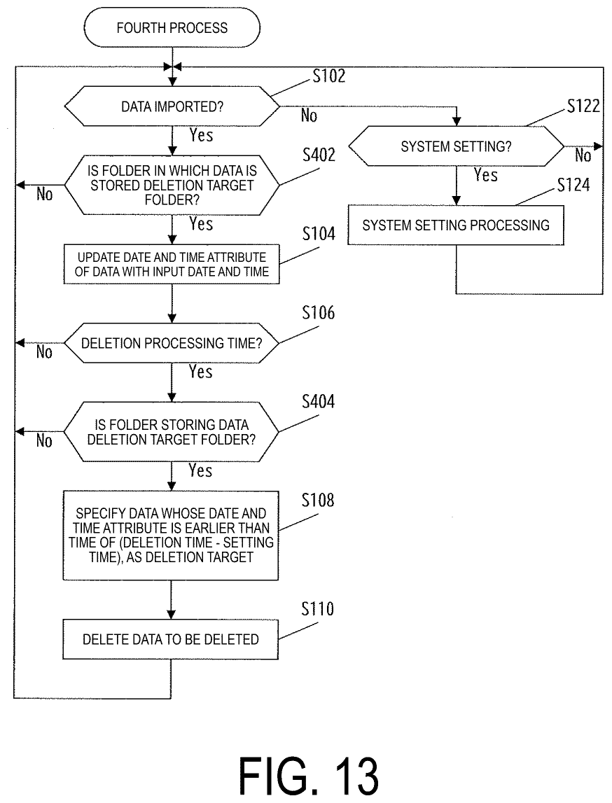

In the fourth embodiment, the controller 100 executes a fourth process in FIG. 13 in place of the first process. Hereinafter, the same processing as that in the first embodiment is denoted by the same reference sign, and description thereof is omitted.

When content data is imported (S102; Yes), the controller 100 judges whether the folder for storing the content data is a folder being set as a deletion target (S402). Here, when a storage destination of the imported content data is a folder that is not set as a deletion target, the controller 100 does not need to update the date and time when the content data has been created, based on the date and time when the content data is imported (S402; No).

On the other hand, when the storage destination of the content data is a folder that is set as a deletion target, the controller 100 updates the date and time attribute of the content data with the date and time at which the content data is imported (S402; Yes→S104).

When the time has come to a deletion processing time (S106; Yes), the controller 100 does not make an automatic deletion judgment for the content data stored in a folder that is not set as a deletion target among pieces of the content data stored in the storage 110 (S404; No→S102).

As described above, according to the present embodiment, among the pieces of the content data, only the content data stored in the deletion target folder is automatically deleted.

Thus, for example, it is considered that the user determines that long-term storage is not necessary for content data stored in an “automatic temporary save folder” (a folder to temporarily save text data of a copy job or the like), and a relatively short period is set to be a set period as the save period for the folder. Accordingly, since there arises a high possibility that the content data is deleted immediately after being imported, the controller 100 can set the imported date and time and the flag information to be stored.

Although the fourth embodiment has been described in the case of being combined with the first embodiment, the fourth embodiment may be combined with the second embodiment or the third embodiment. That is, also in the second process of the second embodiment and the third process of the third embodiment, the controller 100 may execute S402 immediately after “S102; Yes”, and may execute S404 immediately after “S106; Yes”.

### 5. Fifth Embodiment

In the above-described embodiments, it is assumed that the controller 100 always imports content data. In a fifth embodiment, the controller 100 cancels importing of content data, based on a predetermined condition after data import processing is performed.

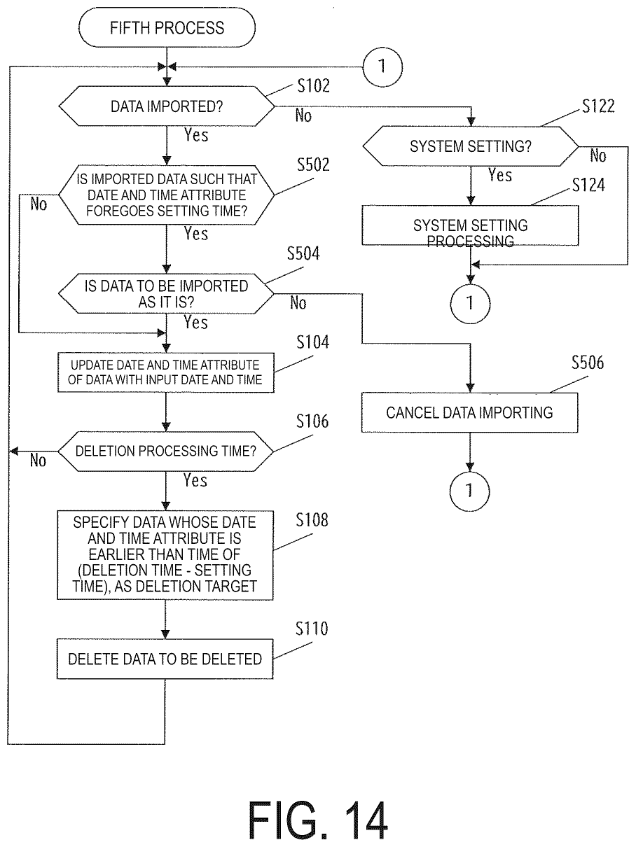

In the fifth embodiment, the controller 100 executes a fifth process in FIG. 14 in place of the first process. Hereinafter, the same processing as that in the first embodiment is denoted by the same reference sign, and description thereof is omitted.

After content data is imported (S102; Yes), the controller 100 judges whether the imported content data is data whose date and time attribute (for example, the date and time when the content data has been created) foregoes the setting time (S502).

For example, when the setting time is six hours, the controller 100 judges whether the attribute of the date and time when the content data has been generated is a time (old time) foregoing the setting time from the time of the importing time point. Further, the controller 100 judges whether the attribute of the date and time when the content data has been generated is a time (old time) foregoing the setting time from the next deletion processing time.

Here, when the date and time when the content data has been created is a time foregoing the setting time from the importing time point or the next deletion processing time, the controller 100 asks the user whether to import the content data as it is (S504). At this time, the user may be notified that the content data will be immediately deleted even if the content data is imported as it is. When the content data is imported as it is, the user may be asked whether to update the date and time attribute of the content data with the input date and time. In a case where the user selects to “import as it is”, the controller 100 judges whether updating the date and time attribute of the content data with the input date and time is selected. In a case where updating the date and time attribute of the content data with the input date and time is selected, the controller 100 executes the process from S104 as in the first process (S504; Yes). In S504, when the user is notified that the content data will be immediately deleted even if the content data is imported as it is, the user may be asked whether to add the flag information to the attributes of the content data in a case of importing the content data as it is. In this case, when the user selects to “import as it is”, the controller 100 judges whether the flag information is added to the attributes of the content data, and in the case where adding the flag information to the attributes of the content data is selected, the controller 100 executes the process from S302 as in the third process.

On the other hand, when the user selects not to import the content data (S504; No), the controller 100 cancels (stops) the importing of the content data (S506).

As described above, in the present embodiment, the user is notified of the content data that may be immediately deleted even if it is imported, and thus the user can select whether to import the content data.

Further, in the present embodiment, whether old content data is regarded as unnecessary depends on the determination of the user, and contents and a type of the content data. Thus, it is preferable for the controller 100 to make the user select whether to allow the import at the time of importing. Therefore, the user may select whether to import each piece of target content data, and a result selected by the user may be applied to all pieces of target content data (for example, content data stored in the same folder, content data similar to the content data selected by the user, content data close in date to the content data selected by the user, and the like).

Although the fifth embodiment has been described in the case of being combined with the first embodiment, the fifth embodiment may be combined with any of the second to fourth embodiments. That is, also in the second process of the second embodiment, the third process of the third embodiment, and the fourth process of the fourth embodiment, the controller 100 may execute S502, S504, and S506 immediately after “S102; Yes”.

### 6. Variations

The present disclosure is not limited to the above-described embodiments, and various modifications are possible.

In other words, embodiments obtained by combining technical mechanisms appropriately changed without departing from the gist of the disclosure are also included in the technical scope.

In the above-described embodiments, the image forming apparatus has been described as an example of the processing apparatus. However, the processing apparatus of the disclosure is applicable to other processing apparatuses. Examples of the processing apparatus may include information processing apparatuses such as a smartphone and a tablet. The information processing apparatus may be a home appliance (for example, an air conditioner, a refrigerator, a television, or the like) equipped with an IoT function. The information processing apparatus is not limited to a stationary device, and may be a portable device or an in-vehicle device, for example. For example, the in-vehicle device may be a device such as a car navigation system.

Although the above-described embodiments have been separately described for convenience of description, the embodiments can be combined and executed within an allowable range. The right of any of the technologies described herein is intended to be acquired through amendment, divisional application, or the like.

The programs running on each device in the embodiments are programs for controlling a CPU or the like (programs for causing a computer to function) to implement the aforementioned functions in the embodiments. Information handled by these devices is temporarily accumulated in a transitory storage device (for example, a RAM) at the time of processing, is then stored in a storage device such as any of various ROMs or an HDD, and is read, corrected, and written by the CPU as needed.

The recording medium storing the programs may be any of a semiconductor medium (for example, a ROM, a non-volatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

Further, when a program is distributed in the market, the program can be stored in a portable recording medium and distributed, or can be transferred to a server computer connected via a network such as the Internet. In this case, it is a matter of course that the storage device of the server device is also included in the disclosure.

Instead of being stored in the device, the above-described data may be stored in an external device and appropriately called. For example, the data may be stored in a Network Attached Storage (NAS) or may be stored on a cloud.

It should be noted that the scope of the disclosure is not limited to the configurations explicitly described herein, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions “in a case where . . . ” and “when . . . ” are described as examples, and the configuration is not limited to the described contents. Configurations not indicated by the descriptions “in a case where . . . ” and “when . . . ” are also disclosed to the extent that the configurations are obvious to a person skilled in the art, and the rights thereof are intended to be acquired.

The processing and the flow of data have been described herein with order, but the order thereof is not limited to the described order. For example, a configuration in which processing is partly removed or the order is rearranged is also disclosed, and the right thereof is intended to be acquired.

Although the functions described in the embodiments are described as being performed in the respective devices, the functions may be implemented in one device or using an external server.

Each functional block or various features of the device used in the above-described embodiments may be implemented or performed by an electric circuit, for example, an integrated circuit or multiple integrated circuits. An electric circuit designed to perform the functions described herein may include a general-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or a combination thereof. A general-purpose processor may be a microprocessor, or any known processor, controller, microcontroller, or state machine. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the present disclosure.

While there have been described what are at present considered to be certain embodiments of the invention, it will be understood that various modifications may be made thereto, and it is intended that the appended claims cover all such modifications as fall within the true spirit and scope of the invention.

1. A processing apparatus comprising:
an acquirer that acquires data including information of a date and time at which the data has been generated as a date and time attribute;
a storage that stores the acquired data; and
at least one controller, wherein
the at least one controller
updates the date and time attribute of the data acquired by the acquirer with a date and time acquired by the acquirer, and
deletes data being present after a lapse of a predetermined period from a date and time of the date and time attribute among pieces of the data in the storage.

2. The processing apparatus according to claim 1, wherein
the acquirer acquires a file as data,
the file includes an attribute in which a date and time at which the file has been saved at an acquisition destination is taken as a save date and time, and
the at least one controller updates the save date and time of the file to a date and time acquired by the acquirer.

3. The processing apparatus according to claim 1, wherein the at least one controller deletes data being present after a lapse of a predetermined period from a date and time acquired by the acquirer among pieces of the data in the storage at a predetermined time interval set by a user.

4. The processing apparatus according to claim 3, wherein the at least one controller
adds flag information to data acquired by the acquirer to make the data become a non-deletion target, and
does not delete, when deleting data stored in the storage at a predetermined time and in a case that the flag information to make the data become a non-deletion target is added, the data but updates the flag information to flag information that makes the data become a deletion target.

5. An image forming apparatus comprising:
an acquirer that acquires content data including a date and time at which the data has been generated as attribute information;
a storage that stores the acquired content data;
an image former that forms an image based on the content data; and
at least one controller, wherein
the at least one controller
updates a date and time attribute of the data acquired by the acquirer with a date and time acquired by the acquirer, and
deletes the content data being present after a lapse of a predetermined period from a date and time of the date and time attribute among pieces of the content data in the storage.

6. A processing method of a processing apparatus, the processing method comprising:
an acquiring step of acquiring data including information of a date and time at which the data has been generated as a date and time attribute;
a storing step of storing the acquired data in a storage;
an updating step of updating the date and time attribute of the data acquired by the acquiring step with a date and time acquired by the acquiring step; and
a deleting step of deleting data being present after a lapse of a predetermined period from a date and time of the date and time attribute among pieces of the data in the storage.
